(19) United States
(12) Patent Application Publication
(10) Pub. No.: US 2017/0159931 A1
(43) Pub. Date: Jun. 8, 2017

(54) WASTE PROCESSING APPARATUS

(71) Applicant: DPS Bristol (Holdings) Limited, Portishead (GB)

(72) Inventor: David John Parkinson, Clevedon (GB)

(73) Assignee: DPS Bristol (Holdings) Limited, Portishead (GB)

(21) Appl. No.: 15/323,732

(22) PCT Filed: Jul. 2, 2015
(86) PCT No.: PCT/GB2015/051939

§ 371 Date: Jan. 3, 2017

(30) Foreign Application Priority Data
Jul. 3, 2014 (GB) 1411920.0

(51) Int. Cl. F23G 5/20; C10B 53/07; F27B 7/16; F23G 5/027

(52) U.S. Cl. CPC F23G 5/20; F23G 5/027; C10B 53/07; F27B 7/161; F23G 2203/208; F23G 2201/30

(57) ABSTRACT

A pyrolyser may include a rotary kiln configured to pyrolyse feedstock material received therein. The pyrolyser may also include a heating vessel surrounding the rotary kiln and defining a heating chamber for hot gases. The pyrolyser may further include an agitator disposed within the heating chamber. The agitator may be configured to agitate the hot gases. The agitator may be rotatable with the rotary kiln.

The invention relates to waste processing apparatus. In particular, the invention relates to a pyrolyser having a heating chamber surrounding a rotary kiln and an agitator rotatable with the rotary kiln; and waste processing apparatus comprising an oxidiser having an oxidation chamber and a sweeping mechanism for removing particulate material deposited in the oxidation chamber.

It is known to process waste by pyrolysis and gasification in modular waste processing apparatus including separate pyrolysis and gasification units. Pyrolysis is the thermal decomposition of matter under the action of heat alone (i.e. in the absence of oxygen), and is an endothermic process. During pyrolysis, a pyrolysis feedstock (such as human or consumer waste) is decomposed to form pyrolysis char and combustible pyrolysis gas.

Gasification is the exothermic reaction of carbonaceous matter, such as pyrolysis char, with oxygen and/or steam to produce combustible syngas. Syngas may include hydrogen, carbon monoxide and carbon dioxide.

The resulting pyrolysis gas and syngas can be combusted to provide thermal energy to sustain the pyrolysis process, and any remaining thermal energy can be converted (e.g. to electricity using a generator) or used onsite.

However, known waste processing apparatus for separately conducting pyrolysis, gasification and combustion suffer from a number of problems.

In particular, particulate material such as ash is known to cause problems in previously considered waste processing apparatus. The deposition and build-up of particulates in an oxidiser and downstream of the oxidiser in a heating chamber for the pyrolyser can reduce the performance of the waste processing apparatus and can result in frequent maintenance and down-time of the apparatus to remove the particulate material. For example, deposition of particulate material on a pyrolysis tube within the heating chamber can result in inefficient heat transfer between the hot gas in the heating chamber and feedstock material received in the pyrolysis chamber.

Particulate material affecting the oxidiser and downstream in the heating chamber for the pyrolyser originates from feedstock material processed in the pyrolyser and gasifier. In particular, particulate material can become separated from the bulk feedstock material in the pyrolyser or the gasifier, and can become entrained in the flow of combustible gas from the pyrolyser and/or the gasifier.

It is therefore desirable to provide an improved waste processing apparatus.

According to an aspect of the invention there is provided a pyrolyser for pyrolysing feedstock material, comprising: a rotary kiln for pyrolysing feedstock material received therein; a heating vessel surrounding the rotary kiln and defining a heating chamber for hot gases therebetween; and an agitator disposed within the heating chamber for agitating hot gas and which is rotatable with the rotary kiln.

Accordingly, the agitator inhibits particulate material entrained in the hot gas from depositing on the rotary kiln. The rotary kiln is at least partly disposed in the heating chamber. The heating vessel may be elongate and the rotary kiln may be elongate.

The agitator may be fixed with respect to the rotary kiln. The agitator may be mounted to the outer surface of the rotary kiln. The agitator may be attached to the rotary kiln or integrally formed with the rotary kiln. The agitator may extend along the length of the rotary kiln. The agitator may be substantially coextensive with the portion of the rotary kiln disposed within the heating chamber.

The agitator may be configured to propel gas over the outer surface of the rotary kiln. Propelling (i.e. accelerating) gas over the outer surface of the rotary kiln may inhibit particulates from depositing on the outer surface of the rotary kiln. The agitator may be arranged to accelerate gas over the outer surface of the rotary kiln to a higher velocity than the mean velocity of hot gas through the heating chamber, thereby improving the rate of heat transfer between the hot gas and the rotary kiln.

The agitator may comprise at least one agitator element in the form of a flight, such as a helical flight. The flight may be arranged to propel hot gas along a direction having an axial component, or substantially axially, when the rotary kiln rotates.

The agitator may comprise at least one agitator element in the form of a fin, such as a planar fin mounted to the rotary kiln. The fin may be normal to the axis of the rotary kiln and arranged to propel hot gas in a substantially tangential direction (i.e. a rotational direction) of the rotary kiln when the kiln rotates. Alternatively, the fin may be inclined from the plane normal to the axis of the rotary kiln and arranged to propel hot gas along a direction having an axial component.

The agitator may comprise a plurality of agitator elements. The or each agitator element may be mounted on the outer surface of the rotary kiln.

There may be a plurality of agitator elements, which may be separated from one another so that hot gas within the heating chamber can flow between the agitator elements.

The agitator may be configured to convey particulate material along the floor of the heating chamber. In other words, the agitator may be configured to convey particulate material along the lower portion of the inner wall of the heating vessel that defines the heating chamber (i.e. the floor). The agitator may be configured to convey a build-up of particulate material (i.e. an accumulation or bed of particulate material that is not gas-borne, but settled on the floor of the heating chamber) along the heating chamber floor.

The floor of the heating chamber (i.e. a lower portion of the heating chamber) may be in the form of a channel, such as a semi-cylindrical channel. The agitator may be configured to agitate particulate material built up in the channel. The agitator may be arranged to correspond to the profile of the floor of the heating chamber. The agitator may be arranged so that in use the clearance between the agitator and the floor is less than 25 cms to less than 15 cms

The heating vessel may comprise a particulate outlet opening into the heating chamber through the floor of the heating chamber, and the agitator may be configured to convey particulate material along the floor towards the particulate outlet. The particulate outlet may comprise an airlock, such as a rotary drum airlock, rotary seal or double flap valve. The particulates discharged through the particulate output may be analysed to determine if the waste processing apparatus is processing the waste in compliance with WID (Waste Incineration Directive—EC Directive 2000/76/EC and/or subsequent revisions) and/or WAC regulations (EC decision 2003/33/EC).

The heating chamber may be substantially cylindrical. At least a lower portion of the heating chamber may be substantially cylindrical. The outer surface of the rotary kiln (not including the agitator) may be substantially cylindrical. References to the heating chamber herein relate to the internal space bounded by the heating vessel.

There is also provided waste processing apparatus comprising: an oxidiser for combusting combustible gas to produce hot gas; and a pyrolyser in accordance with any preceding claim arranged to receive the hot gas from the oxidiser.

The waste processing apparatus may further comprise a feed assembly for conveying waste material into the pyrolyser. The pyrolyser may be configured to generate combustible gas in the form of pyrolysis gas. The waste processing apparatus may further comprise a gasifier for gasifiying pyrolysis char from the pyrolyser to produce combustible gas in the form of syngas.

In one embodiment, the feedstock material comprises plastics materials, such as polyurethane or polystyrene. The pyrolyser of the present invention is particularly suitable for use with plastics as it allows a fuel to be recovered from the hydrocarbons.

Throughout the description and claims of this specification, the words “comprise” and “contain” and variations of the words, for example “comprising” and “comprises”, mean “including but not limited to”, and do not exclude other components, integers or steps. Moreover the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Other features of the invention will become apparent from the following examples. Generally speaking the invention extends to any novel one, or any novel combination, of the features disclosed in this specification (including any accompanying claims and drawings). Thus features, integers or characteristics described in conjunction with a particular aspect, embodiment or example of the invention are to be understood to be applicable to any other aspect, embodiment or example described herein unless incompatible therewith. Moreover unless stated otherwise, any feature disclosed herein may be replaced by an alternative feature serving the same or a similar purpose.

Where upper and lower limits are quoted for a property, then a range of values defined by a combination of any of the upper limits with any of the lower limits may also be implied.

The invention will now be described by reference to the following drawings, in which:

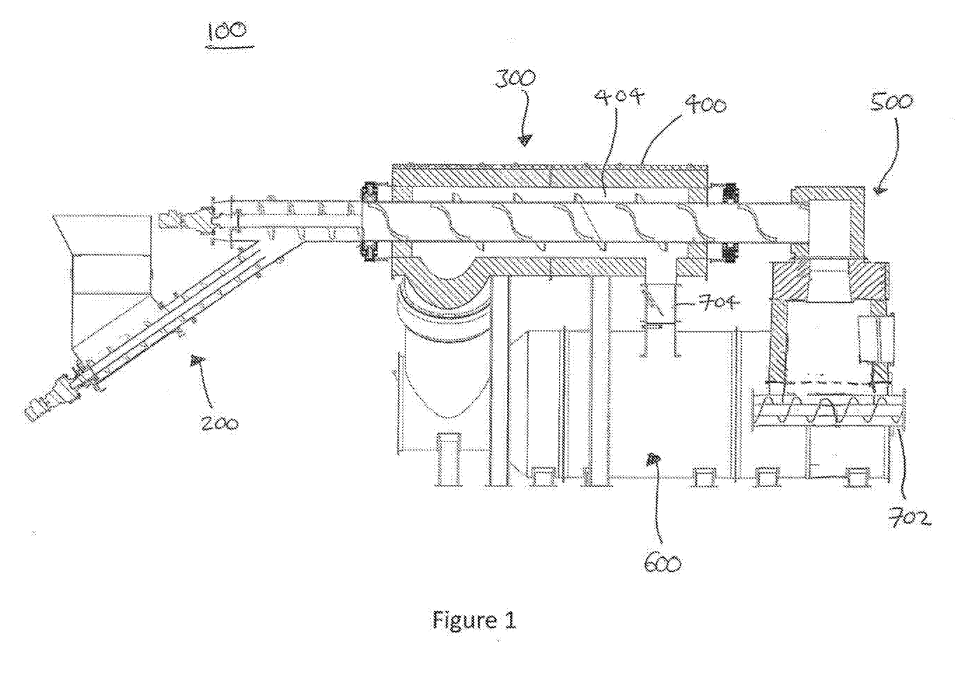

FIG. 1 schematically shows waste processing apparatus according to an embodiment of the invention; and

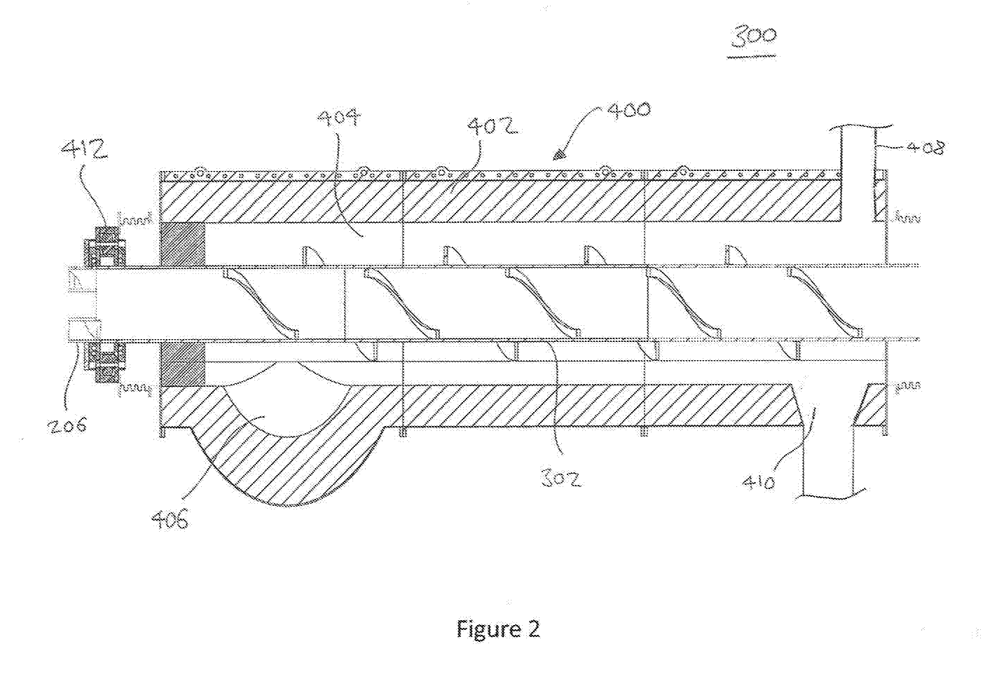

FIG. 2 shows a pyrolyser for the waste processing apparatus of FIG. 1.

FIG. 1 shows waste processing apparatus 100 comprising a feed assembly 200, a pyrolyser 300 including a rotary kiln or rotary pyrolysis tube 302 and a heating vessel 400, a gasifier 500 and an oxidiser 600.

In use, waste is received in the feed assembly 200 and conveyed into the rotary pyrolysis tube 302 of the pyrolyser 300 where it is decomposed under the action of heat to form pyrolysis char and pyrolysis gas. The rotary pyrolysis tube 302 is disposed within the heating chamber 404 of the heating vessel 400, and heat is transferred to the rotary pyrolysis tube 302 from hot gases received within the heating chamber 404. The pyrolysis char and pyrolysis gas exit the rotary pyrolysis tube 302 to enter the gasifier 500, where the pyrolysis char is gasified by the introduction of oxygen and/or steam to produce syngas and ash. The pyrolysis gas and syngas flow together from the gasifier 500 to the oxidiser 600, where the gas is combusted to produce hot gas. The hot gas is redirected to the heating chamber 404 of the heating vessel 400 to heat the rotary pyrolysis tube 302. The hot gas is then directed from the heating chamber 404 to a separate heat recovery unit, such as a steam turbine for power generation.

Ash formed in the gasifier and collected in the oxidiser and heating chamber is collected in an ash bin (not shown) of an ash collection unit by a number of ash ducts 702, 704. The ash duct 704 from the heating vessel 400 comprises a double flap valve to control the release of ash from the heating chamber 400

As shown in FIG. 2, the pyrolyser 300 comprises a static heating vessel 400 including a refractory-lined chamber wall 402 defining an internal heating chamber 404 which receives the rotary pyrolysis tube 302. The internal heating chamber 404 is generally cylindrical and is approximately double the diameter of the cylindrical outer surface the rotary pyrolysis tube 302.

The heating chamber 404 has an inlet 406 for receiving hot gas from the oxidiser 600 and an outlet 408 for discharging hot gas to a heat recovery system (not shown). The inlet 406 is formed in the lower portion of the chamber wall 402 towards the inlet end of the pyrolysis tube 302, and the outlet 408 is formed in the upper portion of the chamber wall 402 towards the outlet end of the pyrolysis tube 302. An ash outlet 410 is formed in the lower portion of the chamber wall towards the outlet end of the pyrolysis tube 302 for collecting particulate material that may build-up in the internal heating chamber 404.

The static heating vessel 400 also comprises a bearing assembly (not shown) outside of the heating chamber 404 and arranged to support the rotary pyrolysis tube 302 at both of its ends, and drive equipment 412 for causing the rotary pyrolysis tube 302 to rotate.

The rotary pyrolysis tube 302 comprises a stainless steel tube of substantially the same diameter as a feed duct 206 of the feed assembly that extends through the heating chamber 400. The pyrolysis tube 302 has an input end adjacent the feed assembly 200 and an outlet end adjacent the gasifier 500. An inlet rotary seal (FIG. 1) forms a seal between the feed assembly 200 and the inlet end of the pyrolysis tube 302 and between the inlet end of the pyrolysis tube and the static housing chamber 400. Further, an outlet rotary seal (FIG. 1) forms a seal between the heating chamber 400 and the outlet end of the pyrolysis tube 302 and between the outlet end of the pyrolysis tube and the gasifier 500.

The pyrolysis tube 302 is provided with a set of internal flights 308 and a gas agitator 310 in the form of a set of external flights 310.

The internal flights 308 are mounted to the inner cylindrical wall of the pyrolysis tube 302 and are provided to break-up waste received in the pyrolysis tube 302 and convey the waste along the length of the pyrolysis tube. The internal flights 308 comprise a number of helical sections joined together to form a continuous helix. In other embodiments the pyrolysis tube 302 may be provided with planar paddles in addition to the flights (i.e. discrete planar projections) in order to assist in the break-up of waste during pyrolysis.

The gas agitator 310 is mounted on the outer surface of the pyrolysis tube 302. In this embodiment the gas agitator 310 comprises external flights in the form of a continuous helix which is configured to accelerate hot gas over the outer surface of the pyrolysis tube 302. In other embodiments, gas agitator elements (such as a plurality of external flights) may be non-continuous so that gas can flow over the outer surface of the rotary pyrolysis tube 302 between the elements. In still further embodiments, the gas agitator 310 may comprise fins or paddles provided on the outer surface of the rotary pyrolysis tube 302, in addition or as an alternative to the helical flights, to accelerate the gas tangentially (i.e. circumferentially with respect to the rotational axis of the rotary pyrolysis tube) and/or axially along the rotary pyrolysis tube 302.

The external flights 310 extend towards the refractory-lined chamber wall 402 so that, in use, the flights 310 engage with any build-up of particulates settled on the floor of the heating chamber 404 (i.e. the inner surface of the lower portion of the heating chamber 404). Since the external flights 310 are helical, they are configured to drive the particulate material along the internal chamber towards the ash outlet 410 so that they can be removed from the heating chamber 404. In other embodiments, planar fins provided on the outer surface of the rotary pyrolysis tube 302 and angled with respect to a plane normal to the rotational axis of the rotary pyrolysis tube 302 may have the same effect of moving the particulate material towards the ash outlet.

In use, waste material is received in the inlet end of the pyrolysis tube 302 from a feed duct 206 of the feed assembly 200. As the pyrolysis tube 302 rotates, heat is transferred from hot gas received in the heating chamber 404 to the pyrolysis tube 302 through the outer surface of the pyrolysis tube 302 and through the external flights 310. This heat is transferred from the rotating pyrolysis tube 302 to the waste within the tube via the inner surface of the tube and the internal flights 308. The rotation of the internal flights 308 causes the waste material to break-up by continuously lifting the waste and allowing it to fall. In addition, the helical shape of the internal flights 308 cause the waste to gradually move through the pyrolysis tube from the inlet end to the outlet end of the tube 302.

Breaking up the waste material during pyrolysis increases the surface area of the waste exposed within the pyrolysis tube and therefore allows for efficient heat transfer from the pyrolysis tube to the waste. In particular, breaking up the waste material can allow the residence time of the waste within the pyrolysis tube to be reduced, and/or the temperature of the heating chamber to be reduced compared with previously considered designs.

As the rotary pyrolysis tube 302 rotates, the gas agitator 310 moves through the hot gas received in the heating chamber 404 of the heating vessel 400 from the oxidiser 600. The rotation of the gas agitator 310 locally accelerates at least the rotational component of the hot gas flow adjacent the surface of the rotary pyrolysis tube 302 so that the flow has a whirl component within the heating chamber 404 and so as to inhibit particulate material entrained in the hot gas flow from depositing on the surface of the rotary pyrolysis tube 302. The gas agitator 310 imparts energy into the flow to inhibit the deposition of the particulate material. The gas agitator 310 may increase the rotational velocity of the hot gas flow so that it has a tangential velocity of up to 5 m/s.

The gas agitator 310 also acts to increase the effective length of the flow path of the hot gas by introducing the whirl component into the flow. This has the compound effect of increasing the local gas flow velocity over the rotary pyrolysis tube 302 for efficient heat transfer, and promotes mixing of the hot gas in the heating chamber 404. Mixing the hot gas in the heat chamber 404 results in efficient heat transfer since it ensures homogeneous flow conditions and prevents portions of the flow from effectively passing straight through the heating chamber 404 without coming into contact with the rotary pyrolysis tube. In contrast, in the absence of the gas agitator 302 the hot gas flow may pass through the heating chamber 404 substantially axially, with only a small annular portion of the flow coming into contact with the rotary pyrolysis tube 302 for heat transfer therewith.

The hot gas received in the heating chamber 404 may have entrained particles, such as ash, from an upstream part of the waste processing apparatus 100. For example, the particles may originate from the input waste material, pyrolysis char, ash generated in the gasifier 500, or any of the above combusted in the oxidiser 600. The gas agitator 310 locally imparts additional energy into the hot gas to accelerate it, which prevents the entrained particles from depositing on the outer surface of the rotary pyrolysis tube 302. The gas agitator 310 therefore prevents a build-up of particles on the pyrolysis tube 310 which would reduce heat transfer efficiency between the hot gas and the pyrolysis tube (and the waste received therein).

In addition, the provision of the gas agitator 310 on the outer surface of the rotary pyrolysis tube 302 increases the effective surface area of the pyrolysis tube 302 for heat transfer. Accordingly, the gas agitator may result in more efficient heat transfer between the hot gas in the heating chamber 404 and the waste received in the pyrolysis tube 302.

1-13. (canceled)

14. A pyrolyser comprising:
a rotary kiln configured to pyrolyse feedstock material received therein;
a heating vessel surrounding said rotary kiln and defining a heating chamber for hot gases; and
an agitator disposed within said heating chamber, wherein said agitator is configured to agitate said hot gases, and wherein said agitator is rotatable with said rotary kiln.

15. The pyrolyser of claim 14, wherein said agitator is fixed with respect to said rotary kiln.

16. The pyrolyser of claim 14, wherein said agitator is mounted to an outer surface of said rotary kiln.

17. The pyrolyser of claim 14, wherein said agitator is configured to propel said hot gases over an outer surface of said rotary kiln.

18. The pyrolyser of claim 14, wherein said agitator comprises at least one flight.

19. The pyrolyser of claim 14, wherein said agitator comprises at least one fin.

20. The pyrolyser of claim 14, wherein said agitator comprises a plurality of agitator elements, and wherein an arrangement of said plurality of agitator elements is configured to cause said hot gases within said heating chamber to flow between said plurality of agitator elements.

21. The pyrolyser of claim 14, wherein said agitator is configured to convey particulate material along a floor of said heating vessel.

22. The pyrolyser of claim 21, wherein a floor of said heating vessel defines a particulate outlet opening, and wherein said agitator is configured to convey particulate material along said floor towards said particulate outlet opening.

23. The pyrolyser of claim 14, wherein said heating chamber is substantially cylindrical.

24. The pyrolyser of claim 14, wherein said feedstock material includes a plastic material selected from a group consisting of polyurethane and polystyrene.

25. A waste processing apparatus comprising:
an oxidiser configured to combust combustible gas to produce hot gas; and
a pyrolyser configured to receive said hot gas from said oxidiser, wherein said pyrolyser includes:
a rotary kiln configured to pyrolyse feedstock material received therein;
a heating vessel surrounding said rotary kiln and defining a heating chamber for hot gases; and
an agitator disposed within said heating chamber, wherein said agitator is configured to agitate said hot gases, and wherein said agitator is rotatable with said rotary kiln.

26. The waste processing apparatus of claim 25, wherein said agitator is fixed with respect to said rotary kiln.

27. The waste processing apparatus of claim 25, wherein said agitator is mounted to an outer surface of said rotary kiln.

28. The waste processing apparatus of claim 25, wherein said agitator is configured to propel said hot gases over an outer surface of said rotary kiln.

29. The waste processing apparatus of claim 25, wherein said agitator comprises at least one flight.

30. The waste processing apparatus of claim 25, wherein said agitator comprises at least one fin.

31. The waste processing apparatus of claim 25, wherein said agitator comprises a plurality of agitator elements, and wherein an arrangement of said plurality of agitator elements is configured to cause said hot gases within said heating chamber to flow between said plurality of agitator elements.

32. The waste processing apparatus of claim 25, wherein said agitator is configured to convey particulate material along a floor of said heating vessel.

33. The waste processing apparatus of claim 32, wherein a floor of said heating vessel defines a particulate outlet opening, and wherein said agitator is configured to convey particulate material along said floor towards said particulate outlet opening.

34. The waste processing apparatus of claim 25, wherein said heating chamber is substantially cylindrical.

35. The waste processing apparatus of claim 25, wherein said feedstock material includes a plastic material selected from a group consisting of polyurethane and polystyrene.
